(19) United States
(12) Patent Application Publication
(10) Pub. No.: US 2026/0359620 A1
(43) Pub. Date: Nov. 12, 2026

(54) MULTICORE-BASED DEEP LEARNING ACCELERATOR AND METHOD FOR OPTIMIZING CORE THEREOF

(71) Applicants: Hyundai Motor Company, Seoul (KR); Kia Corporation, Seoul (KR)

(72) Inventors: Byung Tak LEE, Hwaseong-Si (KR); Young Bae KIM, Hwaseong-Si (KR); Chan Koo LEE, Hwaseong-Si (KR)

(21) Appl. No.: 19/350,706

(22) Filed: Oct. 6, 2025

(30) Foreign Application Priority Data
May 7, 2025 (KR) 10-2025-0058853

(51) Int. Cl. G06N 3/063; G06N 5/04

(52) U.S. Cl. CPC G06N 3/063; G06N 5/04

(57) ABSTRACT

A multicore-based deep learning accelerator includes a neural processing unit including a plurality of cores configured to enable parallel processing of a neural network model and a storage unit storing a first binary configured to cause the plurality of cores to perform inference based on the neural network model and a second binary configured to cause the remaining cores, excluding a portion of the plurality of cores, to perform inference based on the neural network model, wherein the neural processing unit is configured to perform inference based on the neural network model using a core combination configured based on a binary selected from the first binary and the second binary.

### CROSS-REFERENCE TO RELATED APPLICATIONS

This application claims the benefit of priority to Korean Patent Application No. 10-2025-0058853 filed on May 7, 2025 in the Korean Intellectual Property Office, the disclosure of which is incorporated herein by reference in its entirety.

### TECHNICAL FIELD

The present disclosure relates to a multicore-based deep learning accelerator and a method for optimizing a core of the multicore-based deep learning accelerator.

### BACKGROUND

The matters described in this Background section are only for enhancement of understanding of the background of the disclosure, and should not be taken as acknowledgment that they correspond to prior art already known to those skilled in the art.

A deep learning accelerator may be configured to execute inference based on a neural network model trained through deep learning and may include a neural processing unit (NPU). The NPU may have a multicore structure optimized for parallel processing of the neural network model, and the multicore structure may be advantageous in securing scalability of the neural network model. However, even if the multicore structure includes one failed core, the NPU may be determined to be defective and may be discarded.

### SUMMARY

An example of the present disclosure is to provide a multicore-based deep learning accelerator and a method for optimizing a core of the multicore-based deep learning accelerator, capable of enabling inference based on a neural network model regardless of whether a failed core is included and/or reducing the possibility of determining a defect.

According to the present disclosure, an apparatus may comprise a plurality of core circuits configured to perform parallel processing of a neural network model, a memory configured to store first binary data and second binary data, wherein the first binary data is configured to cause the plurality of core circuits to perform an inference process associated with the neural network model, and wherein the second binary data is configured to exclude a portion of the plurality of core circuits and cause the remaining portion of the plurality of core circuits to perform an inference process associated with the neural network model, and a control circuit configured to select, from the memory, one of the first binary data or the second binary data, configure, based on the selected binary data, at least a subset of the plurality of core circuits, and parallel process, using the at least configured subset of the plurality of core circuits, the neural network model.

The apparatus may be such that the second binary data may comprise a plurality of second binaries respectively corresponding to a plurality of different combinations of the plurality of core circuits, and the control circuit may be configured to parallel process the neural network model using a combination of the plurality of core circuits configured based on a selected binary of the first binary data or the plurality of second binaries.

The apparatus may be such that the plurality of different combinations may have different total numbers of core circuits or different combinations of core circuit identification data.

The apparatus may be such that the control circuit may be configured to, via a plurality of data channels, transfer data between a pair of core circuits among the plurality of core circuits, wherein each of the plurality of data channels may be configured to connect a different pair of the plurality of core circuits, and determine whether to activate or deactivate each of the plurality of data channels based on a selected binary of the first binary data or the plurality of second binaries.

The apparatus may be such that the control circuit may be configured to, via a data channel, transfer data between a pair of core circuits among the plurality of core circuits, activate, based on the first binary data being selected, the data channel, and deactivate, based on the second binary data being selected, the data channel.

The apparatus may be such that the neural network model may comprise a plurality of layers, and the control circuit may be configured to divide the plurality of layers into a plurality of layer groups based on a selected binary among the first binary data and the second binary data, and assign each of the plurality of layer groups to a corresponding core circuit of the configured plurality of core circuits.

The apparatus may be such that each of the plurality of core circuits may comprise a processor circuit configured to process an assigned layer group among the plurality of layer groups, a memory configured to store data for processing of the processor circuit, and a controller circuit configured to control the processing circuit, and, based on a selected binary among the first binary data and the second binary data, determine a setting for at least one of communication between the plurality of core circuits, data synchronization between the plurality of core circuits, or memory sharing between the plurality of core circuits.

The apparatus may be such that the memory may comprise a nonvolatile memory configured to store the first binary data and the second binary data, and a volatile memory configured to store a selected binary among the first binary data and the second binary data.

The apparatus may further comprise a second memory configured as a nonvolatile memory to record failed core data associated with failures of core circuits among the plurality of core circuits, wherein the volatile memory may be configured to store a binary corresponding to the failed core data.

The apparatus may further comprise a compiler circuit configured to generate the first binary data and the second binary data based on neural network data, wherein the neural network data may comprise information about the neural network model.

The apparatus may be such that the second binary data may comprise a plurality of second binaries respectively corresponding to a plurality of different combinations of the plurality of core circuits, the control circuit may be configured to parallel process the neural network model using a combination of the plurality of core circuits configured based on a selected binary of the first binary data or the plurality of second binaries, the plurality of different combinations may have different total numbers of core circuits or different combinations of core circuit identification data, and the compiler circuit may be configured to generate the plurality of second binaries such that a minimum number of core circuits, corresponding to the second binaries, required for parallel processing the neural network model is determined based on the neural network data.

According to the present disclosure, an apparatus may comprise a plurality of core circuits configured to perform parallel processing of a neural network model, a memory configured to record failed core data associated with at least one failed core circuit of the plurality of core circuits, and a control circuit configured to, based on the failed core data, select a subset of the plurality of core circuits, wherein the subset is configured to exclude the at least one failed core circuit of the plurality of core circuits, and parallel process, using the selected subset of the plurality of core circuits, the neural network model.

The apparatus may be such that the failed core data may comprise at least one of count data indicating a total number of the at least one failed core circuit or identification data identifying the at least one failed core circuit, and the control circuit may be configured to perform parallel inference processes associated with the neural network model using a combination of the plurality of core circuits, wherein the combination may be determined based on the failed core data to exclude the at least one failed core circuit.

The apparatus may be such that the control circuit may be configured to, via a plurality of data channels, transfer data between a pair of core circuits among the plurality of core circuits, wherein each of the plurality of data channels may be configured to connect a different pair of the plurality of core circuits, and, based on the failed core data, determine whether to activate or deactivate each of the plurality of data channels.

The apparatus may be such that the neural network model may comprise a plurality of layers, and the control circuit may be configured to divide the plurality of layers into a plurality of layer groups based on the failed core data, and assign each of the plurality of layer groups to a corresponding core circuit of the selected subset of the plurality of core circuits.

The apparatus may be such that each of the plurality of core circuits may comprise a processor circuit configured to process an assigned layer group among the plurality of layer groups, a memory configured to store data for processing of the processor circuit, and a controller circuit configured to control processing of the processor circuit, and, based on the failed core data, determine a setting for at least one of communication between the plurality of core circuits, data synchronization between the plurality of core circuits, or memory sharing between the plurality of core circuits.

According to the present disclosure, a method performed by an apparatus may comprise obtaining failed core data associated with failures of core circuits of a plurality of core circuits of the apparatus, generating at least one of first binary data and second binary data, wherein the first binary data may be configured to allow the plurality of core circuits to process a neural network model, and wherein the second binary data may be configured to exclude a portion of the plurality of core circuits and allow the remaining portion of the plurality of core circuits to process the neural network model, providing, from a memory of the apparatus, at least one of the first binary data, the second binary data, or the failed core data to a control circuit of the apparatus, and causing, based on the at least one of the first binary data, the second binary data, or the failed core data, a subset of the plurality of core circuits of the apparatus to parallel process the neural network model.

According to the present disclosure, an apparatus may comprise a plurality of processor circuits configured to parallel process a neural network model, semiconductor test circuitry configured to test the plurality of processor circuits, and a control circuit configured to cause the apparatus to obtain, from the semiconductor test circuitry, identification data identifying whether the plurality of processor circuits have at least one failed processor circuit, store a first set of binary instruction data and a second set of binary instruction data, wherein the first set of binary instruction data may be configured to cause the plurality of processor circuits to process the neural network model based on identification data identifying no failed processor circuit, and wherein the second set of binary instruction data may be configured to cause a subset of the plurality of processor circuits, excluding the at least one failed processor circuit, to process the neural network model, select, based on identification data, one of the first set of binary instruction data or the second set of binary instruction data, and control, based on the selected set of binary instruction data, parallel processing of the neural network model.

### BRIEF DESCRIPTION OF DRAWINGS

The and other examples, features, and advantages of the present disclosure will be more clearly understood from the following detailed description, taken in conjunction with the accompanying drawings, in which:

FIGS. 1A and 1B show an example of a multicore-based deep learning accelerator;

FIG. 2A shows an example of a structure of a multicore-based deep learning accelerator not including a failed core;

FIG. 2B shows an example of a structure of a multicore-based deep learning accelerator including a failed core;

FIG. 3A shows an example of a correspondence relationship between a plurality of cores not including a failed core of a multicore-based deep learning accelerator and a neural network model;

FIGS. 3B, 3C, and 3D show an example of a correspondence relationship between the remaining cores excluding a failed core of a multicore-based deep learning accelerator and a neural network model;

FIG. 4 shows an example of a first binary and a plurality of second binaries of a multicore-based deep learning accelerator;

FIG. 5 shows an example of a multicore-based deep learning accelerator and a method for optimizing a core of a multicore-based deep learning accelerator;

FIGS. 6 and 7 show an example of an operation of a multicore-based deep learning accelerator; and

FIG. 8 shows an example of updating failed core data and/or binary in a multicore-based deep learning accelerator and a method for optimizing a core of a multicore-based deep learning accelerator.

FIG. 9 shows an example computing system.

### DETAILED DESCRIPTION

While the present disclosure may be modified in various ways and take on various alternative forms, specific examples thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc., may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The terms used herein to describe examples of the present disclosure are not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In this specification, vehicles refer to a variety of vehicles that move transported objects, such as people, animals, or goods, from a starting point to a destination. These vehicles are not limited to vehicles that run on roads or tracks.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, a user preference profile, or a regulatory compliance requirement, etc.). Based on one or more features (e.g., feature of fault-tolerant binary-based core reconfiguration) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, lane-keeping control, adaptive cruise control, steering torque control, or obstacle avoidance timing control, etc.). For example, when a first binary is active with all cores available, full autonomous driving functions may be enabled; when a second binary is active due to one failed core, restricted autonomous driving features may be applied (e.g., speed limiting, reduced perception horizon, or delayed lane-change execution, etc.); and when multiple cores fail such that only a minimal binary is valid, critical safety maneuvers may be prioritized (e.g., controlled deceleration, emergency lane-keeping, or safe stop, etc.)

One or more auxiliary devices (e.g., engine brake, exhaust brake, hydraulic retarder, electric retarder, regenerative brake, etc.) may also be controlled, for example, based on one or more features (e.g., feature of fault-tolerant binary-based core reconfiguration) described herein. For example, when a first binary is active with all cores available, auxiliary devices may be fully coordinated for maximum braking efficiency; when a second binary is active due to one failed core, auxiliary braking may be partially limited (e.g., prioritizing regenerative braking while restricting hydraulic retarder engagement, etc.); and when multiple cores fail such that only a minimal binary is valid, auxiliary braking may default to essential safety modes (e.g., engine brake only, reduced retarder torque, or emergency fallback braking, etc.).

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of fault-tolerant binary-based core reconfiguration) described herein. For example, when a first binary is active with all cores available, full-bandwidth communication channels may be enabled (e.g., simultaneous V2X and 5G links, etc.); when a second binary is active due to one failed core, communication may be restricted to reduced-bandwidth or prioritized links (e.g., safety-critical V2X maintained while secondary Wi-Fi services are limited, etc.); and when multiple cores fail such that only a minimal binary is valid, communication may be constrained to essential safety transmissions only (e.g., emergency V2X messages, basic vehicle telemetry, or minimal LTE fallback, etc.).

Minimum risk maneuver (MRM) operation(s) may also be controlled, for example, based on one or more features (e.g., feature of fault-tolerant binary-based core reconfiguration) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. For example, when a first binary is active with all cores available, full MRM functions may be supported (e.g., controlled deceleration combined with lane-change to a shoulder, hazard light activation, or V2X emergency messaging, etc.); when a second binary is active due to one failed core, simplified MRM may be applied (e.g., straight-line controlled deceleration, lane-keeping without lane-change, or reduced signaling, etc.); and when multiple cores fail such that only a minimal binary is valid, the MRM may default to essential fallback actions only (e.g., gradual braking to a safe stop, maintaining current lane, or minimal hazard indication, etc.).

Biased driving operation(s) may also be controlled, for example, based on one or more features (e.g., feature of fault-tolerant binary-based core reconfiguration) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc. For example, when a first binary is active with all cores available, precise biased driving may be supported (e.g., fine lateral offsets dynamically adjusted per sensor fusion, etc.); when a second binary is active due to one failed core, simplified biased driving may be applied (e.g., fixed lateral offset without dynamic recalculation, etc.); and when multiple cores fail such that only a minimal binary is valid, biased driving may default to essential fallback control (e.g., maintaining a coarse offset with minimal computation, etc.).

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of fault-tolerant binary-based core reconfiguration) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). For example, when a first binary is active with all cores available, high-resolution sensor data from all modalities may be processed in real time (e.g., full-frame camera, dense LIDAR point cloud, and high-frequency RADAR, etc.); when a second binary is active due to one failed core, sensor operations may be restricted (e.g., down sampled LIDAR, reduced camera frame rate, or selective RADAR activation, etc.); and when multiple cores fail such that only a minimal binary is valid, sensor operations may be constrained to essential perception only (e.g., basic obstacle detection from RADAR, coarse lane-keeping from camera, or minimal IMU-based stabilization, etc.).

An autonomous driving activation/deactivation operation may be controlled based on a feature of fault-tolerant binary-based core reconfiguration described herein. In particular, a diagnostic control apparatus may determine a core status for a multicore neural processing unit from binary configuration data (e.g., by checking whether failed core data triggers a switch from a first binary using all cores to a second binary using only remaining functional cores) and gate autonomous driving accordingly. When the core status is normal (e.g., all cores are active and operating under the first binary), autonomous driving may be enabled. When the core status is cautionary (e.g., one or more cores are excluded by switching to a second binary but sufficient parallel processing capacity remains), autonomous driving may be restricted (e.g., speed/acceleration limits, limited perception range, or reduced autonomous feature set), and a driver takeover request may be prepared. When the core status is critical (e.g., multiple cores fail such that no valid binary can maintain minimum required parallel processing), autonomous driving may be deactivated and a minimal risk maneuver initiated (e.g., controlled deceleration, lane-keeping to shoulder, or safe stop), while issuing a warning that includes failed core identification data.

According to the present disclosure, an apparatus (e.g., multicore-based deep learning accelerator circuitry) is provided that allows reliable parallel processing of data (e.g., a neural network model) even in the presence of failed processor circuits. The apparatus may include neural processing circuitry comprising a plurality of core processor circuits arranged for parallel processing of the neural network model. When even a single core processor circuit fails, the neural processing circuitry may be deemed defective and discarded. The present disclosure addresses this issue by enabling selective operation of the neural processing circuitry through use of multiple sets of binary data. A first set of binary data may be configured to cause all of the plurality of core processor circuits to process the neural network model when no failure is detected. If one or more failed core processor circuits are detected and excluded, one or more second sets of binary data may be configured to cause the remaining core processor circuits to process the neural network model. Failed core identification data may be recorded and used to select an appropriate set of binary data, thereby enabling the neural processing circuitry to carry out the neural network model processing by a combination of functioning core processor circuits. By dynamically applying the core processor circuits in this manner, the neural processing circuitry may continue to parallel process neural network model while reducing the likelihood of rejection of all of the plurality of core processor circuits due to partial core failure, thereby improving reliability, overall performance of parallel processing, and reducing the cost.

Hereinafter, examples of the present disclosure will be described with reference to the accompanying drawings.

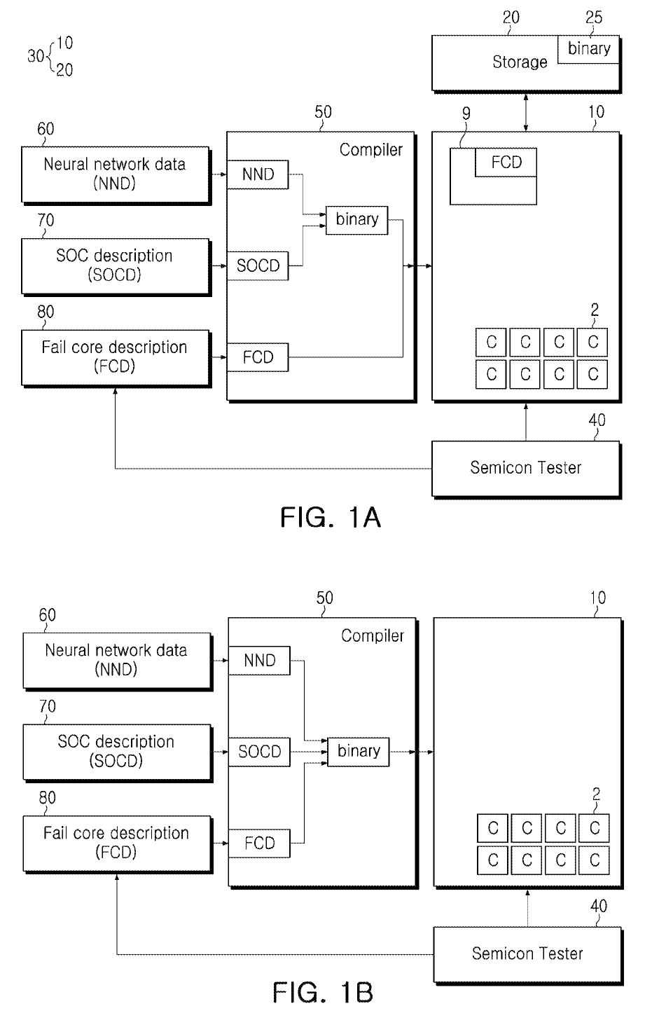

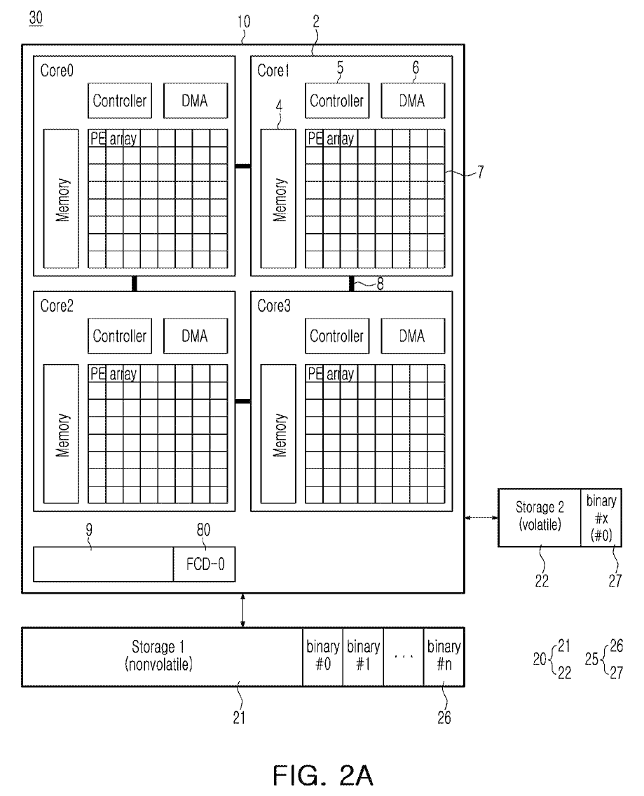

Referring to FIGS. 1A, 2A, and 2B, a multicore-based deep learning accelerator 30 according to an example of the disclosure may include a neural processing unit 10 including a plurality of cores 2 configured to enable parallel processing of a neural network model.

For example, at least a portion of the multicore-based deep learning accelerator 30 may be implemented as a system on chip (SOC), but is not limited thereto. For example, the SOC may further include, but is not limited to, at least one of a central processing unit (CPU), a graphics processing unit (GPU), a digital signal processor (DSP), an image signal processor (ISP), a read-only memory (ROM), a random access memory (RAM), a modem, or an interface controller (e.g., PCIe, USB, or Ethernet, etc.), in addition to the neural processing unit 10.

For example, the neural processing unit 10 may be included in the SOC, and the plurality of cores 2 may be arranged on a single semiconductor chip. Each of the plurality of cores 2 may constitute a sub system including processing, memory, and transmission (e.g., computation logic, cache memory, or bus interface, etc.).

Each of the plurality of cores 2 may include at least one of a processing element 7, a memory 4, a direct memory access (DMA) 6, or a controller 5. The processing element 7 (e.g., a 2D MAC array, a tensor array, or a SIMD array, etc.) may be configured to enable processing of a portion of a neural network model and may have an array structure of a plurality of processing elements 7. The memory 4 may store data for processing of the processing element 7 (e.g., weights, feature maps, or activation values, etc.). The DMA 6 may transfer data between the memory 4 and a storage unit 20 (e.g., flash storage, DRAM, or external memory, etc.).

The controller 5 may control the processing of the processing element 7. For example, at least one controller 5 of the plurality of cores 2 may control at least one of communication between the plurality of cores 2, data synchronization between the plurality of cores 2, or memory sharing between the plurality of cores 2 (e.g., managing broadcast, multicast, or point-to-point communication, etc.) so that the processing element 7 of each of the plurality of cores 2 may simultaneously execute processing. Simultaneously executing processing may refer to parallel processing.

Depending on the design, the neural processing unit 10 may be configured to enable parallel processing for other algorithms (e.g., image compression, cryptographic functions, or matrix factorization, etc.) than the neural network model and may execute parallel processing for the neural network model more efficiently than the other algorithms. That is, the neural processing unit 10 may be optimized for parallel processing for a neural network model.

As the number of the plurality of cores 2 included in the neural processing unit 10 increases, the parallel processing performance of the neural processing unit 10 may be improved. However, as the number of the plurality of cores 2 increases, the possibility that at least one failed core 3 is included in the plurality of cores 2 may increase (e.g., due to aging, thermal stress, or manufacturing variability, etc.).

For example, the failed core 3 may refer to a core in which at least one of the processing element 7, the memory 4, the DMA 6, or the controller 5 is defective. The defect may include a hardware defect (e.g., a wire break/short, a stuck-at fault, or an open circuit, etc.) or a software defect (e.g., a control error, a misconfigured instruction, or a firmware bug, etc.).

The multicore-based deep learning accelerator 30 according to the disclosed example may enable the neural processing unit 10 to parallel process a neural network model (e.g., for performing inference based on the neural network model) regardless of whether the plurality of cores 2 include the failed core 3. Accordingly, the possibility that the neural processing unit 10 is determined as being defective may be reduced, and the overall performance of the parallel processing performance and the fault tolerance of the neural processing unit 10 may be improved.

The multicore-based deep learning accelerator 30 according to the disclosed example may include a storage unit 20 storing a first binary (binary #0) configured to allow the plurality of cores 2 to parallel process a neural network model (e.g., for performing inference based on the neural network model) and a second binary (binary #1, binary #n) configured to allow the remaining cores (excluding some cores (e.g., the failed core 3)) among the plurality of cores 2 to parallel process the neural network model. The neural processing unit 10 may be configured to parallel process a neural network model (e.g., for performing inference based on the neural network model) using a core combination configured based on a binary selected from among the first binary (binary #0) and the second binary (binary #1, binary #n).

For example, the multicore-based deep learning accelerator 30 may select the first binary (binary #0) if there is no failed core 3 among the plurality of cores 2 and may parallel process a neural network model (e.g., for performing inference based on the neural network model) using all of the plurality of cores 2 (e.g., Core0, Core1, Core2, Core3 of FIG. 2A, or in larger arrays Core0–Core7 or Core0–Core15, etc.). For example, the multicore-based deep learning accelerator 30 may select the second binary (binary #1) if the failed core 3 is present among the plurality of cores 2 and may perform inference based on a neural network model using the remaining cores (e.g., Core0, Core1, Core2 of FIG. 2B, or Core0–Core6 when Core7 fails, etc.) excluding the failed core 3 among the plurality of cores 2.

Each of the first binary (binary #0) and the second binary (binary #1) may include commands for executing a neural network model, data flow information, and an optimized operation order (e.g., load instructions, scheduling tables, or memory access sequences, etc.). The multicore-based deep learning accelerator 30 may interpret the first binary (binary #0) or the second binary (binary #1) and execute an appropriate operation through at least some of the plurality of cores 2 (e.g., three active cores, two active cores, or a mixed subset depending on availability, etc.).

Alternatively, the multicore-based deep learning accelerator 30 according to the disclosed example may include a recording station 9 configured to record failed core data 80 of the plurality of cores 2. The neural processing unit 10 may be configured to selectively parallel process the neural network model (e.g., for performing) inference based on the neural network model) using a core combination configured to exclude some cores (e.g., the failed core 3, Core5, or Core7, etc.) among the plurality of cores 2 according to the failed core data 80.

For example, if there is no failed core 3 among the plurality of cores 2, the multicore-based deep learning accelerator 30 may record failed core data FCD-0 corresponding to the information that there is no failed core 3 in the recording station 9 and may parallel process a neural network model (e.g., for performing inference based on the neural network model) by using all of the plurality of cores 2 (e.g., Core0, Core1, Core2, and Core3 of FIG. 2A). For example, when there is a failed core 3 among the plurality of cores 2, the multicore-based deep learning accelerator 30 may record failed core data FCD-1 corresponding to the information that there is a failed core 3 in the recording station 9 and may perform inference based on a neural network model by using the remaining cores (e.g., Core0, Core1, Core2 of FIG. 2B, or 7 out of 8 cores excluding the failed one, etc.) excluding the failed core 3 among the plurality of cores 2.

For example, the recording station 9 may be disposed in the neural processing unit 10 or may be disposed outside the neural processing unit 10 (e.g., within the SOC, in external flash, or in embedded fuse memory, etc.). For example, the recording station 9 may be, but is not limited to, a one-time programmable (OTP) memory included in the SOC (e.g., eFuse, PROM, or secure OTP cells, etc.).

For example, a semiconductor tester 40 may test the plurality of cores 2 and generate the failed core data 80 based on a test result. For example, the semiconductor tester 40 may include, but is not limited to, automatic test equipment (ATE) (e.g., logic testers, memory testers, or SoC functional testers, etc.).

For example, the multicore-based deep learning accelerator 30 may further include a compiler 50 generating the first binary (binary #0) and the second binary (binary #1, binary #n) based on neural network data 60 and/or system-on-chip description (SOCD) data 70. For example, the compiler 50 may be a processor, such as a CPU but is not limited thereto (e.g., a GPU, an FPGA, or a dedicated binary generation accelerator, etc.).

The neural network data 60 may include inference object information, such as information of a neural network model. For example, the neural network data 60 may include neural network graph information, and the neural network model may be a graph neural network (GNN) model (e.g., a convolutional neural network (CNN), a recurrent neural network (RNN), a transformer model, or a deep belief network, etc.) but is not limited thereto.

The SOCD data 70 may include inference subject information. For example, the SOCD data 70 may include at least one of SOC information (e.g., system information), the information (e.g., specification information) of the neural processing unit 10, or the information (e.g., setting information) of each of the plurality of cores 2 (e.g., clock frequency, available memory size, or supported instruction sets, etc.).

The compiler 50 may fuse (e.g., organically link) the inference subject information and the inference object information during a data compiling process, and may generate a binary optimized for inference (e.g., optimized memory allocation, pipeline scheduling, or parallel workload distribution, etc.). If a core combination corresponding to the inference subject information is different, the binary optimized for inference may also be different (e.g., one binary for four active cores or another binary for three active cores, etc.). Accordingly, the compiler 50 may generate a plurality of binaries (including the first and second binaries) as many as the number of cases of the combination of the plurality of cores 2.

The compiler 50 may obtain failed core data FCD from the semiconductor tester 40 and may provide the failed core data FCD and the first binary (binary #0) and the second binary (binary #1, binary #n) to the neural processing unit 10 (e.g., via a bus interface, a shared memory region, or a direct communication channel, etc.).

The neural processing unit 10 may transfer the first binary (binary #0) and the second binary (binary #1, binary #n) to the storage unit 20 and record the failed core data FCD in the recording station 9. The neural processing unit 10 may select one binary among the first binary (binary #0) and the second binary (binary #1, binary #n) in the storage unit 20 according to the failed core data FCD recorded in the recording station 9, and may perform inference based on the neural network model based on the selected binary (e.g., selecting all cores if FCD indicates no failure, or selecting only functional cores if FCD indicates specific failures, etc.).

Referring to FIG. 1B, according to the design, the compiler 50 may generate one selected binary among a plurality of binaries (including the first and second binaries) based on the neural network data (NND), the SOCD data SOCD, and the failed core data FCD. That is, the subject of selecting one of the plurality of binaries (including the first and second binaries) is not limited to the neural processing unit 10. The compiler 50 may provide at least one of the first binary (binary #0), the second binary (binary #1, binary #n), or the failed core data FCD to the neural processing unit 10 (e.g., through an internal compiler interface, a network transfer, or a host CPU instruction, etc.).

Referring to FIGS. 2A and 2B, the storage unit 20 may include a nonvolatile storage unit 21 and/or a volatile storage unit 22. The nonvolatile storage unit 21 may store a plurality of binaries 26 including the first binary (binary #0) and the second binary (binary #1, binary #n). Due to the nonvolatile nature of the nonvolatile storage unit 21, the storage unit of the plurality of binaries 26 may be maintained regardless of ON/OFF of the multicore-based deep learning accelerator 30 (e.g., binaries preserved after power cycling, battery removal, or reset events, etc.).

The volatile storage unit 22 may store one binary 27 selected from the first binary (binary #0) and the second binary (binary #1, binary #n). For example, the volatile storage unit 22 may be RAM, and the RAM may be dynamic RAM (DRAM) but is not limited thereto (e.g., static RAM (SRAM), embedded DRAM (eDRAM), or high-bandwidth memory (HBM), etc.).

For example, the neural processing unit 10 may read a binary corresponding to the failed core data FCD-0 and FCD-1 among the plurality of binaries 26 and may temporarily store the read binary in the volatile storage unit 22 during the reading process. That is, the volatile storage unit 22 may store a binary (binary #0 of FIG. 2A or binary #1 of FIG. 2B) corresponding to the failed core data (FCD-0 of FIG. 2A or FCD-1 of FIG. 2B, or additional FCD codes such as FCD-2 or FCD-3 in larger core systems, etc.).

The neural processing unit 10 may further include a plurality of data channels 8 providing a data transfer path between a corresponding core pair among the plurality of cores 2. Corresponding core pairs of the plurality of data channels 8 may be different from each other. For example, the plurality of data channels 8 may include a first data channel connecting a core Core0 to a core Core1, a second data channel connecting the core Core0 to a core Core2, a third data channel connecting the core Core0 to a core Core3, a fourth data channel connecting the core Core1 to the core Core2, a fifth data channel connecting the core Core1 to the core Core3, and a sixth data channel connecting the core Core2 to the core Core3 (or, in larger designs, channels connecting Core0–Core7, Core2–Core6, or Core4–Core5, etc.).

The neural processing unit 10 may be configured to determine whether to activate each of the plurality of data channels 8 based on one binary 27 selected from among the first binary (binary #0) and the second binary (binary #1, binary #n). The neural processing unit 10 may be configured to determine whether to activate each of the plurality of data channels 8 based on the failed core data 80 (e.g., deactivating channels to/from failed cores while activating channels between remaining active cores, etc.).

Referring to FIG. 2A, the neural processing unit 10 may activate the first, second, fifth, and sixth data channels among the plurality of data channels 8 and deactivate the third and fourth data channels, based on the first binary (binary #0) (e.g., enabling all communication paths when no failure is detected, etc.).

Referring to FIG. 2B, the neural processing unit 10 may activate the first, second, and fourth data channels among the plurality of data channels 8 based on the second binary (binary #1) and deactivate the third, fifth, and sixth data channels (e.g., disabling paths connected to the failed core, while rerouting traffic through healthy cores, etc.).

The neural processing unit 10 may be configured to activate the data channels (e.g., the fifth and sixth data channels) when the first binary (binary #0) is selected, and deactivate the data channels (e.g., the fifth and sixth data channels) when the second binary (binary #1, binary #n) is selected. Accordingly, the performance, as compared to the power consumption, of the neural processing unit 10 may be improved (e.g., achieving higher throughput with more channels active, or lowering power when channels are deactivated, etc.).

The controller 5 of at least one of the plurality of cores 2 may be configured to determine a setting (e.g., latency setting, clock setting, memory cell allocation setting, etc.) for at least one of communication between the plurality of cores 2, data synchronization between the plurality of cores 2, or memory sharing between the plurality of cores 2 based on one binary 27 selected from the first binary (binary #0) and the second binary (binary #1, binary #n). The controller 5 of at least one of the plurality of cores 2 may be configured to determine a setting (e.g., latency setting, clock setting, memory cell allocation setting, etc.) for at least one of communication between the plurality of cores 2, data synchronization between the plurality of cores 2, or memory sharing between the plurality of cores 2 based on failed core data (FCD-0 of FIG. 2A or FCD-1 of FIG. 2B, or other FCD codes reflecting different failed-core patterns, etc.). Accordingly, regardless of whether the plurality of cores 2 include the failed core 3, the parallel processing of the plurality of cores 2 may be efficiently optimized (e.g., performance improvement, as compared to power consumption, maximizing performance under normal conditions, or balancing reduced power under degraded conditions, etc.).

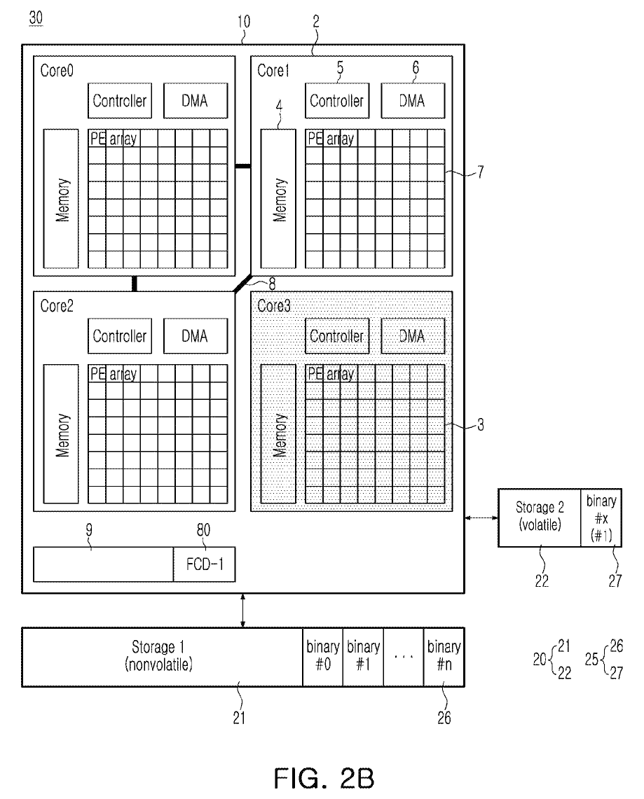

Referring to FIGS. 3A, 3B, 3C, and 3D, the neural network model (NNM) may include a plurality of layers L0, L1, L2, L3, L4, L5, L6, L7, L8, L9, and L10, but the specific configuration of the plurality of layers (e.g., a connection relationship, the number of layers, the number of nodes, activation functions, or data dimensions, etc.) is not limited.

For example, the plurality of layers L0, L1, L2, L3, L4, L5, L6, L7, L8, L9, and L10 may include an input layer L0 to which input data IN is input, an output layer L10 outputting output data OUT, and a plurality of hidden layers L1, L2, L3, L4, L5, L6, L7, L8, and L9. For example, the plurality of layers L0, L1, L2, L3, L4, L5, L6, L7, L8, L9, and L10 may each include one or more nodes and may have a connection structure between all nodes included in each of the adjacent layers (e.g., fully connected, convolutional, or recurrent connections, etc.). The inference process may refer to a process from input data IN to output data OUT (e.g., image recognition, speech translation, or object detection, etc.).

The neural processing unit may be configured to divide the plurality of layers into a plurality of layer groups based on a binary selected from among the first binary (binary #0) and the second binary (binary #1, binary #2, binary #n) and to assign the plurality of layer groups to each core of the core combination. The neural processing unit may be configured to divide the plurality of layers into a plurality of layer groups based on the failed core data (FCD-0 of FIG. 2A or FCD-1 of FIG. 2B) and to assign the plurality of layer groups to each core of the core combination (e.g., grouping shallow layers together, grouping deeper layers together, or balancing layer counts across cores, etc.).

Referring to FIG. 3A, according to the first binary (binary #0) and/or the failed core data (FCD-0 of FIG. 2A), a core combination may include a plurality of cores Core #0, Core #1, Core #2, and Core #3. The neural processing unit may assign a first layer group L0 and L1 to the core Core #0, assign a second layer group L2, L3, and L4 to the core Core #1, assign a third layer group L5, L6, and L7 to the core Core #2, and assign a fourth layer group L8, L9, and L10 to the core (Core #3). According to the first binary (binary #0) and/or the failed core data (FCD-0 of FIG. 2A), a data channel 8-1 may be activated to connect the first layer group L0 and L1 and the second layer group L2, L3, and L4, a data channel 8-2 may be activated to connect the second layer group L2, L3, and L4 and the third layer group L5, L6, and L7, and a data channel 8-3 may be activated to connect the third layer group L5, L6, and L7 and the fourth layer group L8, L9 and L10 (e.g., forming a pipeline across all four cores, etc.).

Referring to FIG. 3B, according to the second binary (binary #1) and/or the failed core data (FCD-1 of FIG. 2B), a core combination may include a plurality of cores Core #0, Core #1, and Core #2. The neural processing unit may assign a first layer group L0, L1, L2, and L3 to the core Core #0, assign a second layer group L4, L5, and L6 to the core Core #2, and assign a third layer group L7, L8, L9 and L10 to the core Core #2. According to the second binary (binary #1) and/or the failed core data (FCD-1 of FIG. 2B), a data channel 8-4 may be activated to connect the first layer group L0, L1, L2, and L3 and the second layer group L4, L5, and L6, and a data channel 8-5 may be activated to connect the second layer group L4, L5, and L6 and the third layer group L7, L8, L9, and L10 (e.g., enabling three-core parallelism when one core fails, etc.). Core identification data of the failed core 3 may be #3, and the number of failed cores 3 may be 1.

Referring to FIG. 3C, according to the second binary (binary #2) and/or the failed core data, a core combination may include a plurality of cores Core #0, Core #1, and Core #3. The neural processing unit may assign a first layer group L0, L1, L2, and L3 to the core Core #0, assign a second layer group L4, L5, and L6 to the core Core #2, and assign a third layer group L7, L8, L9, and L10 to the core Core #3 (e.g., shifting workload when Core #2 fails, etc.). Core identification data of the failed core 3 may be #2, and the number of failed cores 3 may be 1.

Referring to FIG. 3D, according to the second binary (binary #n) and/or the failed core data, a core combination may include a plurality of cores Core #0 and Core #1. The neural processing unit may assign a first layer group L0, L1, L2, L3, L4, and L5 to the core Core #0 and assign a second layer group L6, L7, L8, L9, and L10 to the core Core #2. According to the second binary (binary #n) and/or the failed core data, a data channel 8-6 may be activated to connect the first layer group L0, L1, L2, L3, L4, and L5 and the second layer group L6, L7, L8, L9, and L10 (e.g., operating with only two active cores when two failures occur, etc.). Core identification data of the failed core 3 may be #2 and #3, and the number of failed cores 3 may be 2.

The failed core data may include failed core count data of a plurality of cores (e.g., 1 in FIGS. 3B, 1 in FIG. 3C, and 2 in FIG. 3D, or more in higher-core systems, etc.) or failed core identification data of a plurality of cores (e.g., #3 in FIG. 3B, #2 in FIG. 3C, and #2 and #3 in FIG. 3D, or other combinations such as #1 and #4 in larger arrays, etc.).

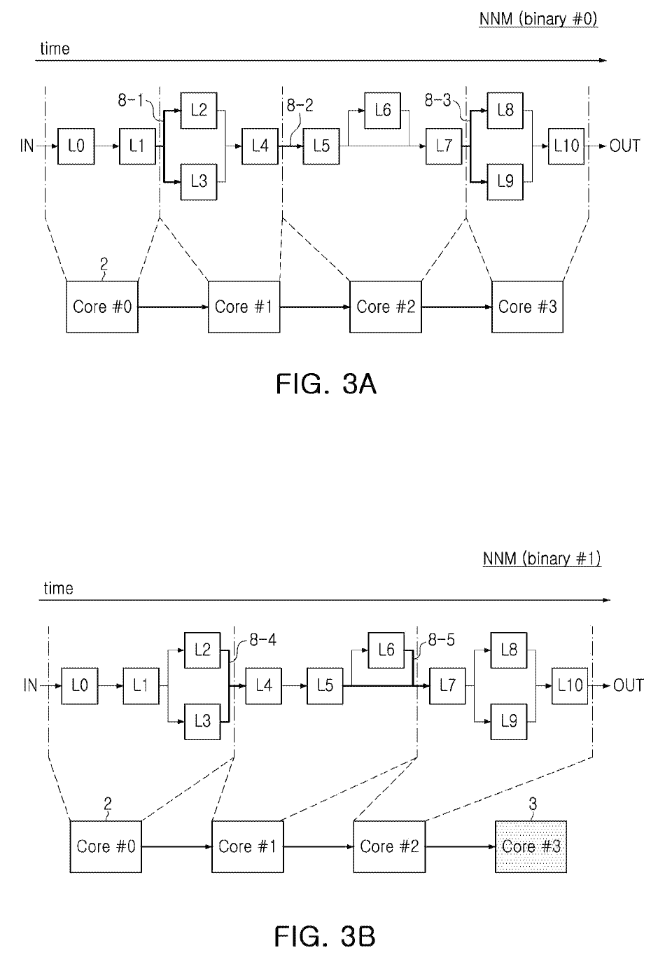

Referring to FIG. 4, the second binary (binary #1, binary #n) may be a plurality of second binaries binary #1, binary #2, binary #3, binary #4, binary #5, binary #6, binary #7, binary #8, binary #9, and binary #n respectively corresponding to different combinations of cores (cores 1+2+3, cores 1+2+4, cores 1+3+4, cores 2+3+4, cores 3+4, cores 2+4, cores 2+3, cores 1+4, cores 1+3, and cores 1+2). The total number of cores (e.g., 2, or 3, or larger sets such as 4, 8, or 16, etc.) of the plurality of second binaries (binary #1, binary #2, binary #3, binary #4, binary #5, binary #6, binary #7, binary #8, binary #9, and binary #n) or combinations of core identification data may be different from each other (e.g., selecting different subsets depending on failed cores, workload distribution, or redundancy needs, etc.). The neural processing unit may be configured to parallel process a neural network model (e.g., to perform inference based on a neural network model) using a combination of cores configured based on the first binary (binary #0) and one selected binary from among a plurality of second binaries.

The compiler (50 of FIG. 1A) may generate a plurality of second binaries 26-1 and 26-2 such that the minimum number (MIN Core) of total cores or the total number (e.g., 4, or 10, or 12, 16, or 32, etc.) of the plurality of second binaries is determined based on the neural network data (60-1, 60-2) (NND-1, NND-2). Accordingly, a binary storage space of the storage unit (20 of FIG. 1A) may be saved (e.g., reducing flash memory usage, optimizing cache requirements, or lowering binary loading latency, etc.).

For example, the required parallel processing performance for inference based on a first neural network model corresponding to the neural network data NND-1 may be lower than the required parallel processing performance for inference based on a second neural network model corresponding to the neural network data NND-2. Accordingly, the minimum number (MIN Core) required for inference based on the first neural network model may be 2 or more, and the minimum number (MIN Core) required for inference based on the second neural network model may be 3 or more (e.g., lightweight models requiring fewer cores versus deep transformer models requiring more, etc.).

For example, the compiler (50 of FIG. 1A) may obtain data that the total number of a plurality of cores is 4 based on the SOCD data (70 of FIG. 1A) and may determine that a difference between the total number of the plurality of cores and the minimum number (MIN Core) is 2 (corresponding to the neural network data NND-1) or 1 (corresponding to the neural network data NND-2), and as the difference is greater, a more plurality of binaries may be generated (e.g., generating 3 binaries for two-core minimum, or 2 binaries for three-core minimum, etc.). n of the second binary (binary #n) may be a natural number corresponding to the number of a plurality of binaries (e.g., 5, 8, 10, or 20, etc.).

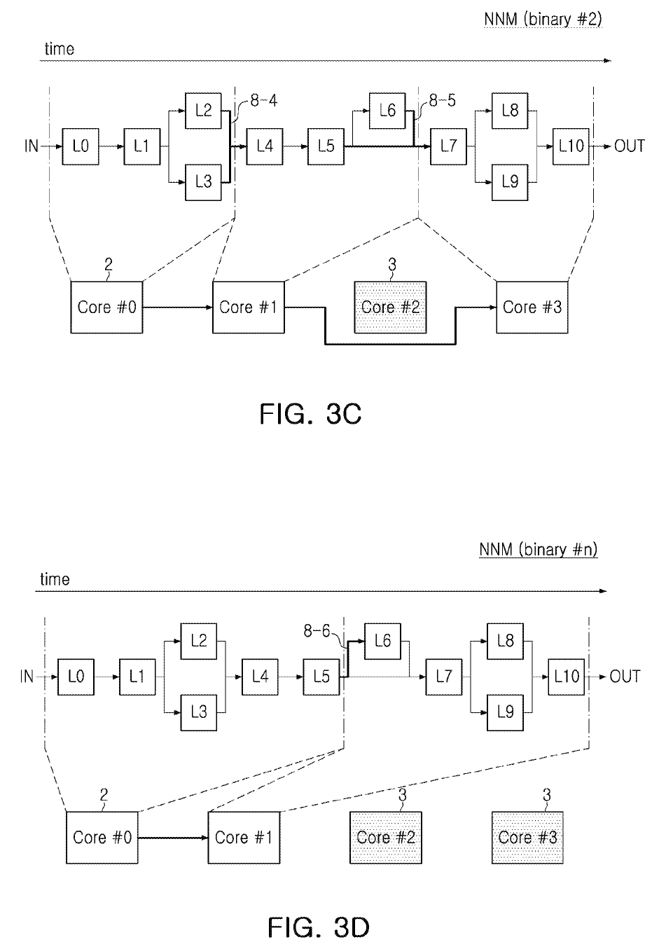

Referring to FIGS. 1A, 1B, and 5, a method for optimizing a core of the multicore-based deep learning accelerator according to the disclosed example includes a test operation (S20) of obtaining failed core data FCD of a plurality of cores 2; a compiling operation (S10) for generating at least one of a first binary configured to allow the plurality of cores 2 to perform inference based on a neural network model or a second binary configured to allow the remaining cores excluding some cores (e.g., a failed core, a disabled core, or a low-power core, etc.) among the plurality of cores 2 to perform inference based on a neural network model (e.g., by parallel processing the neural network model); and a core optimization operation (S30) of providing at least one of the first binary, the second binary, or failed core data FCD to the multicore-based deep learning accelerator 30.

Accordingly, a possibility that the neural processing unit 10 is determined as being defective may be reduced, and the comprehensive performance of the parallel processing performance and the defect prevention of the neural processing unit 10 may be improved. For example, the compiler 50 may execute the method for optimizing a core of the multicore-based deep learning accelerator (e.g., by adapting binaries dynamically, pruning unused cores, or reallocating workloads, etc.).

For example, the core optimization operation (S30) may include providing the first binary and the second binary to the storage unit 20 of the multicore-based deep learning accelerator 30 and may include providing the failed core data FCD to the recording station 9 of the multicore-based deep learning accelerator 30. For example, the compiling operation (S10) may include generating a plurality of second binaries so that the minimum number of total cores or the total number of the plurality of second binaries is determined based on the neural network data 60 (e.g., CNN data, transformer graph data, or LSTM sequence data, etc.).

In the compiling operation (S10), the multicore-based deep learning accelerator 30 may obtain a plurality of binaries (including the first and second binaries) based on the neural network data 60 (S11) and may store the plurality of binaries (including the first and second binaries) in the storage unit 20 (S12) (e.g., in nonvolatile flash, NVRAM, or external storage, etc.).

In the test operation (S20), the multicore-based deep learning accelerator 30 may obtain the failed core data FCD based on the semiconductor tester 40 (S21) and store the failed core data FCD in the recording station 9 (S22) (e.g., OTP memory, fuse memory, or embedded NVM, etc.).

In the core optimization operation (S30), the multicore-based deep learning accelerator 30 may select one of a plurality of binaries (including the first and second binaries) according to the failed core data FCD (S31), execute parallel processing of a core combination configured based on the (selected) binary (S32), and perform inference based on a neural network model of the neural network data 60 (S33) (e.g., classification, detection, or prediction tasks, etc.).

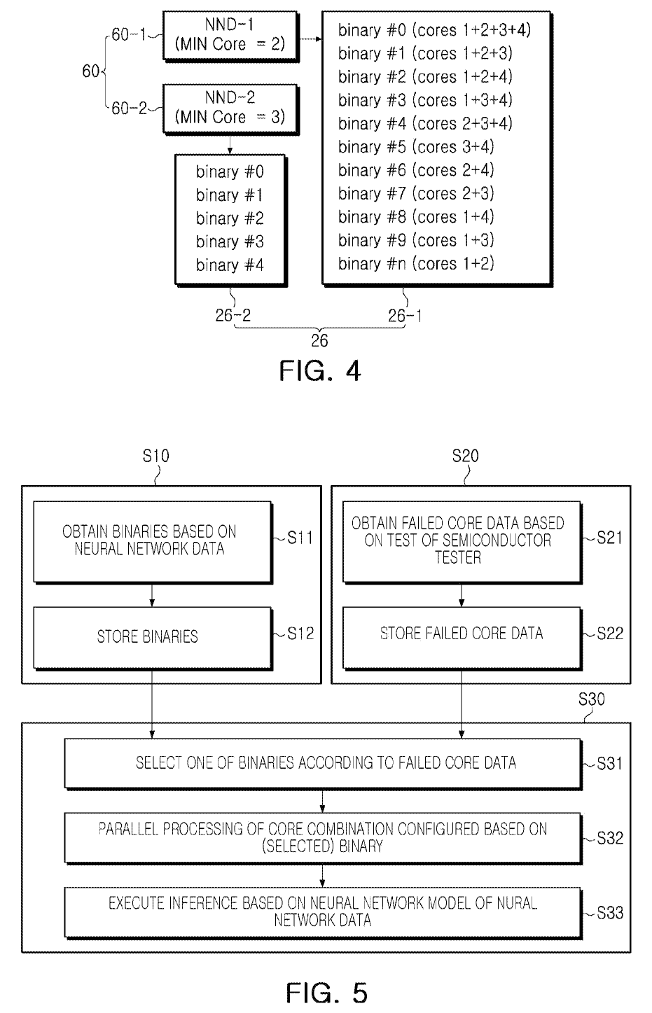

The order of the compiling operation (S10) and the test operation (S20) is not particularly limited. Alternatively, the compiling operation (S10) and the test operation (S20) may be integrated into one operation (e.g., S15 of FIG. 6). The compiling operation (S10), the test operation (S20), and the one operation (e.g., S15 of FIG. 6) may be executed before a first inference of the multicore-based deep learning accelerator 30 (e.g., before release (i.e., shipment) after manufacturing according to the semiconductor process, during wafer-level testing, or during package-level testing, etc.), but are not limited thereto.

Referring to FIGS. 1A and 6, the multicore-based deep learning accelerator 30 may obtain a binary based on the neural network data 60 and failed core data FCD (S15) and may check whether a failed core has occurred (or the number or identification data (ID)) based on the binary (S34) (e.g., detecting a stuck-at fault, a timing violation, or a memory access failure, etc.).

If a failed core does not occur, the multicore-based deep learning accelerator 30 may execute inference (S33) based on the neural network model of the neural network data through parallel processing (S35) of the plurality of cores 2 (e.g., 4 cores, 8 cores, or 16 cores in larger implementations, etc.).

If a failed core occurs, the multicore-based deep learning accelerator 30 may execute inference based on the neural network model of the neural network data (S33) through parallel processing (S36) of the remaining cores among the plurality of cores 2 excluding the failed core (e.g., 3 of 4 cores, 7 of 8 cores, or 15 of 16 cores, etc.).

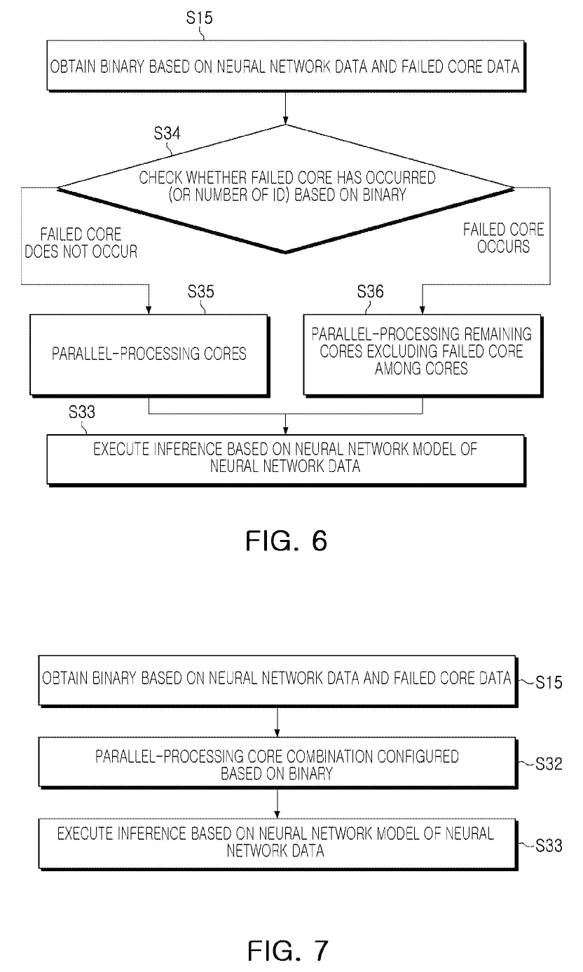

Referring to FIGS. 1A and 7, the multicore-based deep learning accelerator 30 may obtain a binary based on the neural network data 60 and the failed core data FCD (S15) and execute inference based on the neural network model of the neural network data (S33) through parallel processing (S32) of a core combination configured based on the binary (e.g., allocating heavier layers to active cores or redistributing skipped layers, etc.).

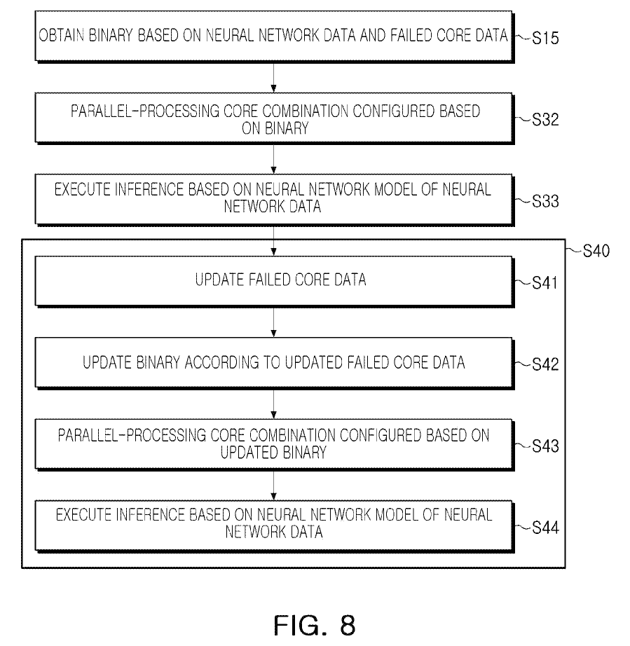

Referring to FIGS. 1A and 8, the core optimization operation may include updating failed core data (S40) after the multicore-based deep learning accelerator 30 infers based on the neural network model (e.g., after parallel processing (S32) and inference execution (S33)). For example, the update (S40) may be a multicore-based deep learning accelerator after manufacturing and shipping according to a semiconductor process (e.g., field operation, stress testing, or long-term deployment, etc.).

For example, during the update (S40), the compiler 50 may update the failed core data FCD (S41) and update the binary according to the updated failed core data (S42). For example, during the update (S40), the multicore-based deep learning accelerator 30 may execute inference (S44) based on the neural network model of the neural network data through parallel processing (S43) of the core combination configured based on the updated binary (e.g., regenerating binaries for 3 active cores, 6 active cores, or 12 active cores, etc.).

For example, before shipment after manufacturing according to the semiconductor process, the multicore-based deep learning accelerator not including a failed core may execute parallel processing (S32) of the core combination (Core0, Core1, Core2, and Core3 of FIG. 2A) configured based on the first binary (binary #0 of FIG. 2A) and/or failed core data (FCD-0 of FIG. 2A). Thereafter, according to long-term inference of the multicore-based deep learning accelerator, some of the plurality of cores included in the multicore-based deep learning accelerator may be switched from normal cores to failed cores (e.g., due to aging, heat stress, or electromigration, etc.). According to the update (S40), the multicore-based deep learning accelerator may update the failed core data (FCD-0 of FIG. 2A) to the failed core data (FCD-1 of FIG. 2B) (S41) and update the first binary (binary #0 of FIG. 2A) to the second binary (binary #1 of FIG. 2B) (S42). The multicore-based deep learning accelerator may execute parallel processing (S32) of the core combination (Core0, Core1, and Core2 of FIG. 2B) configured based on the updated failed core data (FCD-0 of FIG. 2A) and/or the second binary (binary #1 of FIG. 2B) (e.g., ensuring continuity of inference despite degraded hardware, etc.).

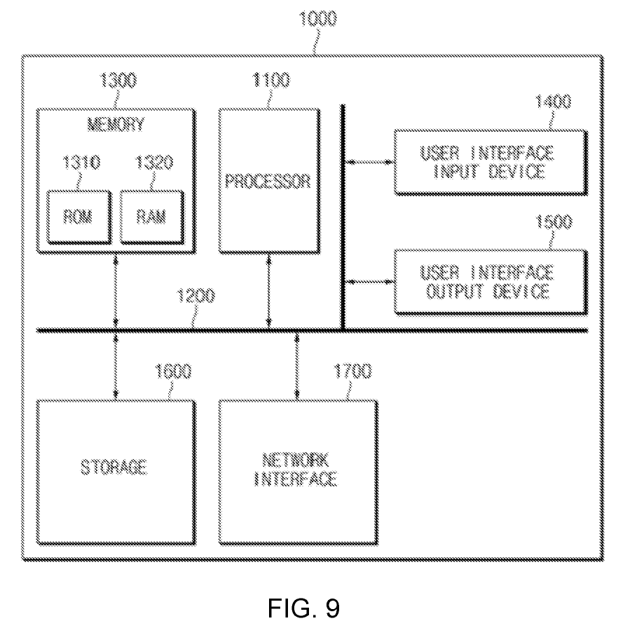

FIG. 9 shows an example computing system (e.g., a computing device of a multicore-based deep learning accelerator 30). One or more controllers, processors, etc. described herein, such as one or more components of the multicore-based deep learning accelerator 30 (e.g., a neural processing unit 10), one or more components of a semiconductor tester 40, and any other components and devices disclosed herein, may be implemented by or in the computing system as shown in FIG. 9.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, a multicore-based deep learning accelerator includes: a neural processing unit including a plurality of cores configured to enable parallel processing of a neural network model; and a storage unit storing a first binary configured to cause the plurality of cores to perform inference based on the neural network model and a second binary configured to cause the remaining cores, excluding a portion of the plurality of cores, to perform inference based on the neural network model, wherein the neural processing unit is configured to perform inference based on the neural network model using a core combination configured based on a binary selected from the first binary and the second binary.

According to another example of the present disclosure, a multicore-based deep learning accelerator includes: a neural processing unit including a plurality of cores configured to enable parallel processing of a neural network model; and a recording station configured to record failed core data of the plurality of cores, wherein the neural processing unit is configured to perform inference based on the neural network model by using a core combination configured by excluding a portion of the plurality of cores selectively, according to the failed core data.

According to another example of the present disclosure, a method for optimizing a core of a multicore-based deep learning accelerator, in a method for setting up a multicore-based deep learning accelerator including a plurality of cores configured to enable parallel processing of a neural network model, includes: a test operation of acquiring failed core data of the plurality of cores; a compiling operation of generating at least one of a first binary configured to allow the plurality of cores to perform inference based on the neural network model or a second binary configured to allow the remaining cores, excluding a portion of the plurality of cores, to perform inference based on the neural network model; and a core optimization operation of providing at least one of the first binary, the second binary, or the failed core data to the multicore-based deep learning accelerator.

The multicore-based deep learning accelerator and the method for optimizing a core of the multicore-based deep learning accelerator according to the disclosed example may enable inference based on a neural network model regardless of whether a failed core is included and may reduce the possibility of determining a defect. Therefore, the comprehensive performance of parallel processing performance and defective prevention may be improved.

While examples have been shown and described above, it will be apparent to those skilled in the art that modifications and variations could be made without departing from the scope of the present disclosure as defined by the appended claims.

What is claimed is:

1. An apparatus comprising:
a plurality of core circuits configured to perform parallel processing of a neural network model;
a memory configured to store first binary data and second binary data, wherein the first binary data is configured to cause the plurality of core circuits to perform an inference process associated with the neural network model, wherein the second binary data is configured to exclude a portion of the plurality of core circuits and cause the remaining portion of the plurality of core circuits to perform an inference process associated with the neural network model; and
a control circuit configured to:
select, from the memory, one of the first binary data or the second binary data,
configure, based on the selected binary data, at least a subset of the plurality of core circuits, and
parallel process, using the at least configured subset of the plurality of core circuits, the neural network model.

2. The apparatus claim 1, wherein the second binary data comprises a plurality of second binaries respectively corresponding to a plurality of different combinations of the plurality of core circuits, and
wherein the control circuit is configured to parallel process the neural network model using a combination of the plurality of core circuits configured based on a selected binary of the first binary data or the plurality of second binaries.

3. The apparatus of claim 2, wherein the plurality of different combinations have different total numbers of core circuits or different combinations of core circuit identification data.

4. The apparatus of claim 3, wherein the control circuit is configured to:
via a plurality of data channels, transfer data between a pair of core circuits among the plurality of core circuits, wherein each of the plurality of data channels is configured to connect a different pair of the plurality of core circuits, and
determine whether to activate or deactivate each of the plurality of data channels based on a selected binary of the first binary data or the plurality of second binaries.

5. The apparatus of claim 1, wherein the control circuit is configured to:
via a data channel, transfer data between a pair of core circuits among the plurality of core circuits,
activate, based on the first binary data being selected, the data channel, and
deactivate, based on the second binary data being selected, the data channel.

6. The apparatus of claim 1, wherein the neural network model comprises a plurality of layers, and
wherein the control circuit is configured to divide the plurality of layers into a plurality of layer groups based on a selected binary among the first binary data and the second binary data, and
assign each of the plurality of layer groups to a corresponding core circuit of the configured plurality of core circuits.

7. The apparatus of claim 6, wherein
each of the plurality of core circuits comprises:
a processor circuit configured to process an assigned layer group among the plurality of layer groups;
a memory configured to store data for processing of the processor circuit; and
a controller circuit configured to:
control the processing circuit,
based on a selected binary among the first binary data and the second binary data, determine a setting for at least one of:
communication between the plurality of core circuits,
data synchronization between the plurality of core circuits, or
memory sharing between the plurality of core circuits.

8. The apparatus of claim 1, wherein
the memory comprises:
a nonvolatile memory configured to store the first binary data and the second binary data; and
a volatile memory configured to store a selected binary among the first binary data and the second binary data.

9. The apparatus of claim 8, further comprising
a second memory configured as a nonvolatile memory to record failed core data associated with failures of core circuits among the plurality of core circuits,
wherein the volatile memory is configured to store a binary corresponding to the failed core data.

10. The apparatus of claim 9, further comprising a compiler circuit configured to generate the first binary data and the second binary data based on neural network data, wherein the neural network data comprises information about the neural network model.

11. The apparatus of claim 10, wherein
the second binary data comprises a plurality of second binaries respectively corresponding to a plurality of different combinations of the plurality of core circuits,
wherein the control circuit is configured to parallel process the neural network model using a combination of the plurality of core circuits configured based on a selected binary of the first binary data or the plurality of second binaries,
wherein the plurality of different combinations have different total numbers of core circuits or different combinations of core circuit identification data, and
wherein the compiler circuit is configured to generate the plurality of second binaries such that a minimum number of core circuits, corresponding to the second binaries, required for parallel processing the neural network model is determined based on the neural network data.

12. An apparatus comprising:
a plurality of core circuits configured to perform parallel processing of a neural network model;
a memory configured to record failed core data associated with at least one failed core circuit of the plurality of core circuits; and
a control circuit configured to:
based on the failed core data, select a subset of the plurality of core circuits, wherein the subset is configured to exclude the at least one failed core circuit of the plurality of core circuits, and
parallel process, using the selected subset of the plurality of core circuits, the neural network model.

13. The apparatus of claim 12, wherein
the failed core data comprises at least one of count data indicating a total number of the at least one failed core circuit or identification data identifying the at least one failed core circuit, and
the control circuit is configured to perform parallel inference processes associated with the neural network model using a combination of the plurality of core circuits, wherein the combination is determined based on the failed core data to exclude the at least one failed core circuit.

14. The apparatus of claim 13, wherein
the control circuit is configured to:
via a plurality of data channels, transfer data between a pair of core circuits among the plurality of core circuits,
each of the plurality of data channels is configured to connect a different pair of the plurality of core circuits, and
based on the failed core data, determine whether to activate or deactivate each of the plurality of data channels.

15. The apparatus of claim 12, wherein
the neural network model comprises a plurality of layers, and
wherein the control circuit is configured to:
divide the plurality of layers into a plurality of layer groups based on the failed core data, and
assign each of the plurality of layer groups to a corresponding core circuit of the selected subset of the plurality of core circuits.

16. The apparatus of claim 15, wherein
each of the plurality of core circuits comprises:
a processor circuit configured to process an assigned layer group among the plurality of layer groups;
a memory configured to store data for processing of the processor circuit; and
a controller circuit configured to:
control processing of the processor circuit,
based on the failed core data, determine a setting for at least one of:
communication between the plurality of core circuits,
data synchronization between the plurality of core circuits, or
memory sharing between the plurality of core circuits.

17. A method performed by an apparatus, the method comprising:
obtaining failed core data associated with failures of core circuits of a plurality of core circuits of the apparatus;
generating at least one of first binary data and second binary data, wherein the first binary data is configured to allow the plurality of core circuits to process a neural network model, and wherein the second binary data is configured to exclude a portion of the plurality of core circuits and allow the remaining portion of the plurality of core circuits to process the neural network model;
providing, from a memory of the apparatus, at least one of the first binary data, the second binary data, or the failed core data to a control circuit of the apparatus; and
causing, based on the at least one of the first binary data, the second binary data, or the failed core data, a subset of the plurality of core circuits of the apparatus to parallel process the neural network model.

18. The method of claim 17, wherein
the providing the at least one of the first binary data, the second binary data, or the failed core data comprises:
providing the first binary data and the second binary data to a first memory of the apparatus, and
providing the failed core data to a second memory of the apparatus.

19. The method of claim 17, further comprising updating the failed core data after the parallel process of the neural network model.

20. An apparatus comprising:
a plurality of processor circuits configured to parallel process a neural network model;
semiconductor test circuitry configured to test the plurality of processor circuits; and
a control circuit configured to cause the apparatus to:
obtain, from the semiconductor test circuitry, identification data identifying whether the plurality of processor circuits have at least one failed processor circuit,
store a first set of binary instruction data and a second set of binary instruction data,
wherein the first set of binary instruction data is configured to cause the plurality of processor circuits to process the neural network model based on identification data identifying no failed processor circuit, and
wherein the second set of binary instruction data is configured to cause a subset of the plurality of processor circuits, excluding the at least one failed processor circuit, to process the neural network model,
select, based on identification data, one of the first set of binary instruction data or the second set of binary instruction data, and
control, based on the selected set of binary instruction data, parallel processing of the neural network model.
